(19) United States
(12) Patent Application Publication
(10) Pub. No.: US 2018/0075514 A1
(43) Pub. Date: Mar. 15, 2018

(54) METHOD AND SYSTEM FOR DATA PROCESSING FOR GENERATING ADAPTIVE RECOMMENDATIONS OF RELEVANT ITEMS

(71) Applicant: XEROX CORPORATION, Norwalk, CT (US)

(72) Inventors: Sriganesh Madhvanath, Pittsford, NY (US); Elizabeth D. WAYMAN, Ontario, CA (US)

(21) Appl. No.: 15/266,180

(22) Filed: Sep. 15, 2016

(51) Int. Cl. G06Q 30/06; G06Q 50/00

(52) U.S. Cl. CPC G06Q 30/0631; G06Q 50/01

(57) ABSTRACT

The disclosed embodiments illustrate method and system for data processing by a computing device for generating adaptive recommendations of relevant items. The method includes receiving data associated with a first user from one or more data sources. The method further includes generating one or more item recommendations based on at least a gap value of a parameter corresponding to the first user with respect to a reference value of the parameter, and one or more association factors of the plurality of second users with one or both of each item in the plurality of items and the first user. The method further includes transmitting the generated one or more item recommendations to a mobile computing device associated with the first user over the communication network, wherein the generated one or more item recommendations are selectable by the first user, at the mobile computing device, for item utilization.

### TECHNICAL FIELD

The presently disclosed embodiments are related, in general, to data processing. More particularly, the presently disclosed embodiments are related to method and system for data processing by a computing device for generating adaptive recommendations of relevant items.

### BACKGROUND

Given advancements in the field of information technology there are numerous tools and applications, such as recommendation systems, that help customers who intend to purchase items, such as products and/or services, on a regular basis via online stores and/or physical stores. Such recommendation systems utilize purchase or transaction history of the customers to recommend items. For example, a recommendation system may recommend a customer, who regularly purchases dairy products, to purchase a newly launched variety of cheese.

Generally, such recommendation systems are designed to cater to various requirements, such as market penetration, of service providers by analyzing the details, such as purchase or transaction history, of the customers. Thus, the aspect of relevance for a customer is mostly overlooked. Further, such recommendations fail to meet certain personalized requirements or goals, such as a fixed diet plan or fixed quality of services, of the customers. Therefore, a dynamic and adaptive recommendation system is required that recommends relevant items to the customers based on their personalized requirements or goals.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method of data processing by a computing device for generating adaptive recommendations of relevant items. The method includes receiving, by one or more transceivers in the computing device, data associated with a first user from one or more data sources over a communication network, wherein the data comprises an item list associated with the first user and information of a plurality of second users connected to the first user in a social networking graph. The method further includes generating, by one or more processors in the computing device, one or more item recommendations based on at least a gap value of a parameter corresponding to the first user with respect to a reference value of the parameter, and one or more association factors of the plurality of second users with one or both of each item in the plurality of items and the first user. The method further includes transmitting, by the one or more transceivers, the generated one or more item recommendations to a mobile computing device associated with the first user over the communication network, wherein the generated one or more item recommendations are selectable by the first user, at the mobile computing device, for item utilization.

According to embodiments illustrated herein, there is provided a system for generating adaptive recommendations of relevant items. The system includes one or more processors configured to receive data associated with a first user from one or more data sources over a communication network by utilizing one or more transceivers, wherein the data comprises an item list associated with the first user and information of a plurality of second users connected to the first user in a social networking graph. The system includes the one or more processors further configured to generate one or more item recommendations based on at least a gap value of a parameter corresponding to the first user with respect to a reference value of the parameter, and one or more association factors of the plurality of second users with one or both of: each item in the plurality of items and the first user. The system further includes the one or more processors further configured to transmit the generated one or more item recommendations to a mobile computing device associated with the first user over the communication network by utilizing the one or more transceivers, wherein the first user provides a feedback, associated with item utilization, on the generated one or more item recommendations at the mobile computing device.

According to embodiments illustrated herein, there is provided a computer program product for use with a computing device. The computer program product comprises a non-transitory computer readable medium storing a computer program code of data processing for generating adaptive recommendations of relevant items. The computer program code is executable by one or more processors to receive data associated with a first user from one or more data sources over a communication network by utilizing one or more transceivers, wherein the data comprises an item list associated with the first user and information of a plurality of second users connected to the first user in a social networking graph. The computer program code is further executable by the one or more processors to generate one or more item recommendations based on at least a gap value of a parameter corresponding to the first user with respect to a reference value of the parameter, and one or more association factors of the plurality of second users with one or both of each item in the plurality of items and the first user. The computer program code is further executable by the one or more processors to transmit the generated one or more item recommendations to a mobile computing device associated with the first user over the communication network by utilizing the one or more transceivers, wherein the first user provides a feedback, associated with item utilization, on the generated one or more item recommendations at the mobile computing device.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram that illustrates a system environment, in which various embodiments can be implemented, in accordance with at least one embodiment;

FIG. 2 is a block diagram that illustrates an application server, in accordance with at least one embodiment;

FIG. 3 is a flowchart that illustrates a method for generating adaptive recommendations of relevant items, in accordance with at least one embodiment;

FIG. 4 is a block diagram that illustrates an exemplary scenario for generating adaptive recommendations of relevant food items, in accordance with at least one embodiment; and

FIG. 5 is a block diagram that illustrates an exemplary scenario for presenting one or more item recommendations to a user on a mobile computing device, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### Definitions

The following terms shall have, for the purposes of this application, the meanings set forth below.

A “plurality of items” refers to an inventory of a plurality of utility products, such as food items, and/or services, such as various beauty services at salon or exercise programs at a fitness center, available at one or more online and/or physical stores. For example, a plurality of food items, such as fruits, vegetables, dairy products, packaged food products (i.e., breakfast cereals, soups, chips, etc.), and/or the like, available in a grocery store may correspond to the plurality of items. In an embodiment, each item in the plurality of items may be associated with a parameter. For example, food items are associated with nutrition.

An “item list” refers to a list of items that a user purchases and/or avails for utilization on a periodic basis, based on observation over an extended period of time, such as a year. In an embodiment, the item list may be associated with a time period. For example, over the period of observation, a user purchases some food items periodically, such as “1 kg mangoes” each month, “1 kg apples” each week, and “1 kg potatoes” every day for consumption. In such a case, these food items constitute the item list for the user. The item list associated with the time period “one week” may be estimated based on pro-rating as “¼ kg mangoes, 1 kg apples, 7 kg potatoes.” It may be noted that the scope of the disclosure is not limited to any specific time period, such as “one week” as stated above. The time period can be as short as a day or as long as one year or longer as convenient.

“One or more item recommendations” refer to personalized recommendations, for a first user that comprise information pertaining to one or more relevant items. In an embodiment, the one or more item recommendations may further comprise information pertaining to one or more second users associated with the corresponding one or more relevant items. In other words, the one or more item recommendations may either correspond to implicit recommendations comprising one or more relevant items, or explicit recommendations comprising one or more relevant items and along with information pertaining to the one or more second users associated the corresponding one or more relevant items. In an embodiment, the one or more item recommendations are generated to fulfill a personalized requirement, such as an RDA goal, of the first user. Further, in an embodiment, the one or more item recommendations may be generated based on a gap value of a parameter corresponding to the first user with respect to a reference value of the parameter and one or more association factors. For example, “Your friend A gets her vitamin C from oranges, you may include 500 g of oranges in your daily diet to fulfill your nutrition requirement of vitamin C” may represent an item recommendation in which “daily intake of 500 g of oranges” corresponds to the relevant item and “user A” corresponds to the second user associated with the relevant item.

A “first user” refers to an individual for whom the one or more item recommendations are generated. For example, one or more food item recommendations may be generated to fulfill an RDA goal of a user “A.” In this scenario, the user “A” corresponds to the first user.

A “plurality of second users” refers to users who are directly or indirectly connected to a first user in a social networking graph. In an embodiment, the connection between the first user and the plurality of second users may be a uni-directional connection or a bi-directional connection. In an instance, when the connection between the first user and the plurality of second users corresponds to the bi-directional connection, a consent (or an approval) may be required from the first user and/or each of the plurality of second users before the establishment of the bi-directional connection. In another instance, a consent may not be required when the connection between the first user and the plurality of second users corresponds to the uni-directional connection. For example, a social networking website may have “3” registered users, such as users “A,” “B,” and C.” Further, with “B's” consent, the user “A” has added the user “B” as his/her contact in his/her social profile. Further, with “C's” consent, the user “B” has added the user “C,” in his/her social profile on the social networking website. In this scenario, the user “A” is directly connected to the user “B” and indirectly connected to the user “C.” Thus, the users “B” and “C” may correspond to the plurality of second users for the user “A,” the users “A” and “C” may correspond to the plurality of second users for the user “B,” and the users “A” and “B” may correspond to the plurality of second users for the user “C.”

“Social networking graph” refers to a graph that depicts connections between a plurality of users, who are registered on one or more social networking websites. In an embodiment, the social networking graph comprises a set of nodes connected by a set of undirected weighted edges. A node in the set of nodes represents a user in the plurality of users. In an embodiment, two nodes connected by an undirected weighted edge in the social networking graph may represent direct connections. In an embodiment, the weight of the undirected weighted edge between two nodes in the social networking graph may represent trust between the two users associated with the two nodes.

“Profile information” refers to personal details of a user. In an embodiment, the profile information may comprise information pertaining to demographic details, medical details, educational details, professional details, and/or entertainment preference details of the user.

A “value of a parameter” refers to a value of a feature that depicts the properties of an item. For example, a nutrition value, such as 186 calories, 0.4 g fats, 15 g sugar, and 24 g proteins of a food item depicts amount and type, such as calories, fats, sugar, and proteins, of nutrients per serving in the food item. In this case, nutrition is the parameter associated with the food item.

A “cumulative value” of a parameter refers to a value obtained when the values of the parameter associated with each item in an item list are aggregated. In an embodiment, the cumulative value of the parameter may be associated with a time period corresponding to the item list. For example, a weekly food item list comprises: 1 kg mangoes with nutrition value 599 calories, 3.86 g fats, 137 g sugar, and 8.33 g proteins; 1 kg potatoes with nutrition value 742.5 calories, 1 g fats, 6.75 g sugar, and 20.25 proteins; and 1 kg apples with nutrition value 520 calories, 0 g fats, 100 g sugar, and 4 g proteins. Thus, the cumulative nutrition value associated with the weekly food item list may be represented as 1861.5 calories, 4.86 g fats, 445.75 g sugar, and 32.58 g proteins. Further, the cumulative nutrition value may be associated with the time period “one week” corresponding to the food item list.

A “reference value of a parameter” refers to a predetermined value of the parameter corresponding to a user. For example, a user may have a recommended daily allowance (RDA) goal that sets a daily reference nutrition intake for the user. In this scenario, the reference nutrition intake may correspond to the reference value of the parameter. Further, the reference value of the parameter may be associated with a time period. In an embodiment, the reference value of the parameter may be associated with a time period different from a time period associated with an item list. In this scenario, the reference value of the parameter may be normalized based on the time period associated with the item list. For example, the item list may correspond to a weekly food item list and a daily reference nutrition value of the “user A” may be based on an RDA goal. In this scenario, the daily reference nutrition value of the “user A” may be normalized to weekly reference nutrition value based on the time period “one week” associated with the food item list.

A “gap value” refers to a difference between a cumulative value of a parameter associated with an item list and a reference value of the parameter, associated with a first user. Further, in an embodiment, the gap value may be associated with a time period corresponding to the cumulative value of the parameter associated with the item list and the reference value of the parameter. In other words, the cumulative value of the parameter associated with the item list and the reference value of the parameter may be normalized to same time period and the gap value may be associated with the normalized time period. For example, a difference between a cumulative nutrition value of a food item list and a reference nutrition value associated with the first user may correspond to the gap value. In a scenario, when the gap value comprises more than one elements, the gap value may be represented as a gap vector. Hereinafter, the terms “gap value” and “gap vector” may be used interchangeably, without altering the scope of the disclosure.

A “first score” refers to a score for an item that is indicative of a similarity between a value of a parameter of the item and a gap value corresponding to a first user. The first score may depict how efficiently the item addresses the gap value corresponding to the first user.

A “second score” refers to a score for an item that is indicative of an association of the item with a plurality of second users (i.e., direct or indirect connections of a first user). In an embodiment, the second score may be determined based on an affinity score of the plurality of second users with the item and a trust score between the plurality of second users and the first user.

A “third score” refers to a score that is determined based on an implicit or explicit feedback of a user on one or more item recommendations. In an embodiment, the third score may be determined for each item in a plurality of items based on the feedback of the user. In other words, the third score corresponds to a feedback score or an adoption score that is determined based on the (implicit or explicit) feedback provided by the user.

“One or more association factors” represent an association of a plurality of second users with an item in a plurality of items and a first user. In an embodiment, the one or more association factors may comprise a first association factor and a second association factor.

A “first association factor” of a plurality of second users with an item in a plurality of items is determined based on an affinity score of the plurality of second users with the item. The first association factor may be indicative of an affinity of the plurality of second users for the item.

A “second association factor” of a plurality of second users with an item in a plurality of items is determined based on a trust score between the plurality of second users and a first user. The second association factor may be indicative of the trust between the plurality of second users and the first user.

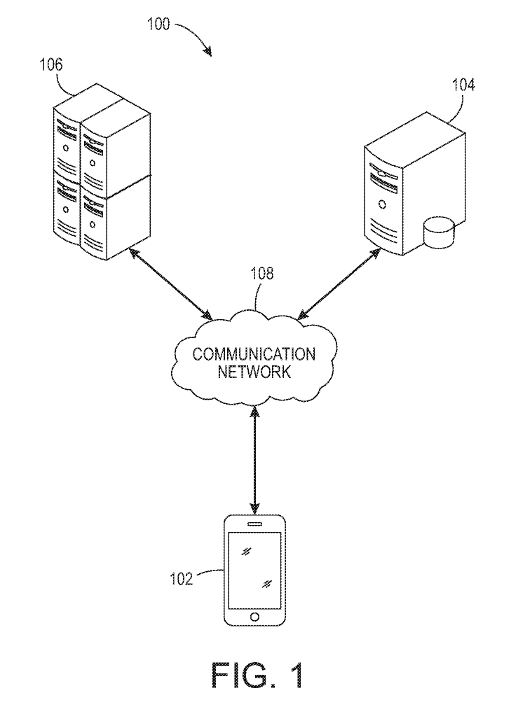

FIG. 1 is a block diagram of a system environment in which various embodiments may be implemented. With reference to FIG. 1, there is shown a system environment 100 that includes one or more mobile computing devices, such as a mobile computing device 102, one or more database servers, such as a database server 104, one or more application servers, such as an application server 106, and a communication network 108. Various devices in the system environment 100 may be interconnected over the communication network 108. FIG. 1 shows, for simplicity, one mobile computing device, such as the mobile computing device 102, one database server, such as the database server 104, and one application server, such as the application server 106. However, it will be apparent to a person having ordinary skill in the art that the disclosed embodiments may also be implemented using multiple mobile computing devices, multiple database servers, and multiple application servers, without departing from the scope of the disclosure.

The mobile computing device 102 may refer to a computing device (associated with a first user) that may be communicatively coupled to the communication network 108. The first user may correspond to a customer, who may utilize the mobile computing device 102 to provide various inputs. For example, the first user may utilize the mobile computing device 102 to provide inputs for one or more transactions to purchase items from a plurality of items. In an embodiment, the plurality of items may correspond to one of: a plurality of food items, a plurality of training items, and a plurality of service items.

The mobile computing device 102 may include one or more processors and one or more memory units. The one or more memory units may include a computer readable code that may be executable by the one or more processors to perform one or more operations specified by the first user. In an embodiment, the first user may utilize the mobile computing device 102 to access one or more social networking websites over the communication network 108. Further, the first user may have created one or more social profiles on the one or more social networking websites by utilizing the mobile computing device 102. Further, such one or more social networking websites may have a plurality of users (including the first user) who are connected to each other through a social networking graph.

For example, a social networking website may have “4” registered users, such as users “A,” “B,” C,” and “D.” The user “A” may have created a social profile on the social networking website. Further, the user “A” has added the user “B” and the user “C,” as his/her contacts in his/her social profile. Further, the user “B” has added the user “D,” in his/her social profile on the social networking website. In this scenario, the connections between the users “A,” “B,” “C,” and “D” on the social networking website may be represented as the social networking graph. In this scenario, the user “A” is directly connected to the users “B” and “C,” so the users “B” and “C” are the direct connections, and indirectly connected to user “D,” so the user “D” is an indirect connection of the user “A.” Similarly, the social networking graph may be utilized to determine the direct connections and the indirect connections of other registered users, such as the users “B,” “C” and “D.”

A person having ordinary skill in the art will understand that the abovementioned example is for illustrative purpose and should not be construed to limit the scope of the disclosure.

Further, in an embodiment, the first user may further utilize the mobile computing device 102 to perform one or more transactions to purchase items from the plurality of items. Thus, local memory of the mobile computing device 102 may store information pertaining to all the previous transactions (i.e., purchase history) of the first user. In an embodiment, the first user may store an item list in the local memory of the mobile computing device 102. In an embodiment, the item list may comprise items from the plurality of items that the first user may want to purchase.

In an embodiment, the first user may utilize the local memory of the mobile computing device 102 for storing his/her profile information. In an embodiment, the profile information of the first user may comprise information such as, but not limited to, demographic details, medical details, educational details, professional details, and entertainment preference details of the first user. In an embodiment, the demographic details may comprise details pertaining to the age, sex, and/or address of the first user. Further, the medical details may comprise details pertaining to an RDA goal, medical allergies, prohibited food items, and/or the like of the first user. Further, educational details may comprise details pertaining to educational qualifications, such as grades, cumulative grade point averages (CGPA), majors, minors, degrees and honors of the first user. Further, the professional details may comprise details pertaining to the job history and professional skill set of the user. And the entertainment preference details may comprise details pertaining to first user's interest in various entertainment categories, such as movies, songs and/or the like. In an embodiment, the profile information of the first user may further comprise information pertaining to one or more service appointment details of the first user.

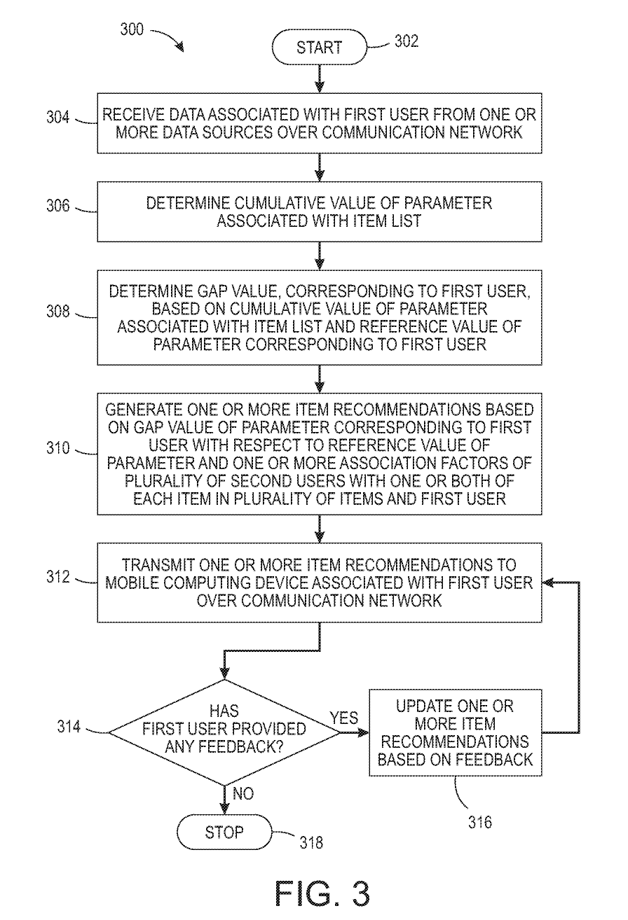

In an embodiment, the mobile computing device 102 may present a user interface, received from the application server 106, to the first user for displaying one or more item recommendations to the first user. In an embodiment, the first user may utilize the mobile computing device 102 to provide feedback for the one or more item recommendations to the application server 106. In an embodiment, the first user may utilize the mobile computing device 102 to select or reject the one or more item recommendations. The selection and/or rejection of the one or more item recommendations may correspond to a feedback. In an embodiment, the selection and/or rejection of the one or more item recommendations may correspond to an explicit feedback. In another embodiment, the first user may utilize the mobile computing device 102 to provide an implicit feedback. Further details of the feedback are explained later in FIG. 3.

The mobile computing device 102 may correspond to a variety of portable computing devices, such as, but not limited to, a laptop, a PDA, a smartphone, and a phablet.

A person having ordinary skill in the art will understand that the scope of the disclosure is not limited to the utilization of the mobile computing device 102 by a single user. In an embodiment, the mobile computing device 102 may be utilized by more than one user.

The database server 104 may refer to a computing device that may be communicatively coupled to the communication network 108. In an embodiment, the database server 104 may be configured to perform one or more database operations. The one or more database operations may include one or more of, but are not limited to, receiving, storing, processing, and transmitting one or more queries, data, or content. The one or more queries, data, or content may be received/transmitted from/to various components of the system environment 100. In an embodiment, the database server 104 may be configured to store the social networking graph of the first user. In an embodiment, the database server 104 may be configured to store information pertaining to each item in the plurality of items. In an embodiment, the information may comprise a value of a parameter of each item in the plurality of items. Examples of the value of the parameter may comprise, but are not limited to, a nutrition value when the plurality of items correspond to the plurality food items, a skill-set value when the plurality of items correspond to the plurality of training items, and a quality of service value when the plurality of items correspond to the plurality of service items.

In an embodiment, the database server 104 may be configured to receive one or more queries from the application server 106 to retrieve the social networking graph of the first user and information pertaining to each item in the plurality of items. For querying the database server 104, one or more querying languages (such as, but not limited to, SQL, QUEL, and DMX) may be utilized. In an embodiment, the database server 104 may connect to the application server 106, using one or more protocols, such as, but not limited to, the ODBC protocol and the JDBC protocol. In an embodiment, the database server 104 may be realized through various technologies such as, but not limited to, Microsoft® SQL Server, Oracle®, IBM DB2®, Microsoft Access®, PostgreSQL®, MySQL®, and SQLite®.

The application server 106 may refer to a computing device or a software framework hosting an application or a software service that may be communicatively coupled to the communication network 108. In an embodiment, the application server 106 may be implemented to execute procedures, such as, but not limited to, programs, routines, or scripts stored in one or more memory units for supporting the hosted application or the software service. In an embodiment, the hosted application or the software service may be configured to perform one or more predetermined operations. In an embodiment, the application server 106 may be configured to receive data associated with the first user from one or more data sources, such as the database server 104 and/or the local memory of the mobile computing device 102, over the communication network 108. In an embodiment, the data may comprise the item list associated with the first user and information of a plurality of second users connected to the first user in the social networking graph.

Thereafter, the application server 106 may be configured to query the database server 104 to retrieve the information pertaining to each item in the plurality of items. Further, the application server 106 may be configured to identify the value of the parameter of each item in the item list by utilizing the retrieved information pertaining to each item in the plurality of items. Further, in an embodiment, the application server 106 may be configured to utilize the identified value of the parameter of each item in the item list for determining a cumulative value of the parameter associated with the item list.

In an embodiment, the application server 106 may be configured to retrieve the profile information of the first user from the mobile computing device 102. After retrieval, the application server 106 may be configured to determine a gap value, corresponding to the first user, based on the cumulative value of the parameter associated with the item list and a reference value of the parameter corresponding to the first user. In an embodiment, the application server 106 may be configured to identify the reference value of the parameter based on the profile information of the first user.

In an embodiment, the application server 106 may be further configured to generate the one or more item recommendations based on the gap value of the parameter corresponding to the first user with respect to the reference value of the parameter, and one or more association factors of the plurality of second users with one or both of each item in the plurality of items and the first user. In an embodiment, the one or more association factors may comprise a first association factor and a second association factor. In an embodiment, the first association factor may be based on an affinity score of the plurality of second users with the item in the plurality of items. Further, the second association factor may be based on a trust score between the plurality of second users and the first user. In an embodiment, each item recommendation in the one or more item recommendations may comprise details of one or more items from the plurality of items and/or details of one or more second users, in the plurality of second users, who are associated with the one or more items in the corresponding item recommendation. Thereafter, the application server 106 may be configured to transmit the one or more item recommendations to the mobile computing device 102.

In an embodiment, the application server 106 may be configured to receive the feedback provided by the first user on the one or more item recommendations from the mobile computing device 102. In an embodiment, the application server 106 may be further configured to update the one or more item recommendations based on the feedback. Further, the application server 106 may be configured to transmit the updated one or more item recommendations to the mobile computing device 102. In an embodiment, the application server 106 may be configured to present the one or more item recommendations to the first user through the user interface.

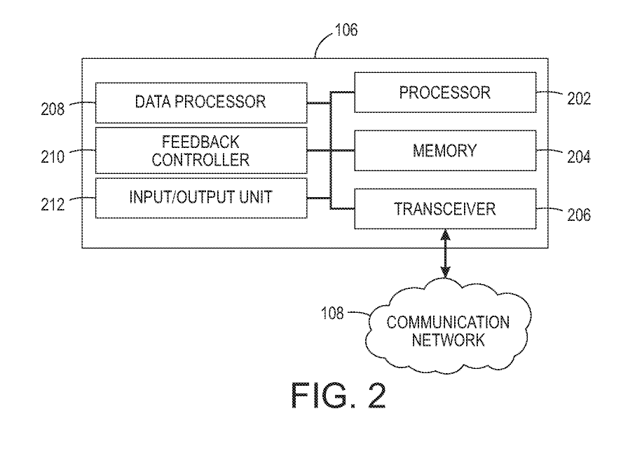

The application server 106 may be realized through various types of application servers, such as, but not limited to, a Java application server, a .NET framework application server, a Base4 application server, a PHP framework application server, or any other application server framework. An embodiment of the structure of the application server 106 has been discussed later in FIG. 2.

A person having ordinary skill in the art will appreciate that the scope of the disclosure is not limited to realizing the application server 106 and the mobile computing device 102, as separate entities. In an embodiment, the application server 106 may be realized as an application program installed on and/or running on the mobile computing device 102, without deviating from the scope of the disclosure. Further, in an embodiment, the functionalities of the database server 104 can be integrated into the functionalities of the application server 106, without departing from the scope of the disclosure.

The communication network 108 may correspond to a medium through which content and messages flow between various devices, such as the mobile computing device 102, the database server 104, and the application server 106 of the system environment 100. Examples of the communication network 108 may include, but are not limited to, the Internet, a cloud network, a Wireless Fidelity (Wi-Fi) network, a Wireless Local Area Network (WLAN), a Local Area Network (LAN), a wireless personal area network (WPAN), a wireless wide area network (WWAN), a cloud network, a Long Term Evolution (LTE) network, a plain old telephone service (POTS), and/or a Metropolitan Area Network (MAN). Various devices in the system environment 100 can connect to the communication network 108 in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as Long Term Evolution (LTE), Light Fidelity (Li-Fi), and/or other cellular communication protocols or Bluetooth (BT) communication protocols.

FIG. 2 is a block diagram that illustrates an application server, in accordance with at least one embodiment. FIG. 2 is described in conjunction with FIG. 1. With reference to FIG. 2, there is shown a block diagram of the application server 106 that may include a processor 202, a memory 204, a transceiver 206, a data processor 208, a feedback controller 210, and an input/output (I/O) unit 212. The processor 202 is communicatively coupled to the memory 204, the transceiver 206, the data processor 208, the feedback controller 210, and the I/O unit 212.

The processor 202 includes suitable logic, circuitry, and/or interfaces that are configured to execute one or more instructions stored in the memory 204. The processor 202 may further comprise an arithmetic logic unit (ALU) (not shown) and a control unit (not shown). The ALU may be coupled to the control unit. The ALU may be configured to perform one or more mathematical and logical operations and the control unit may control the operation of the ALU. The processor 202 may execute a set of instructions/programs/codes/scripts stored in the memory 204 to perform one or more operations for generating adaptive recommendations of relevant items for the first user. In an embodiment, the processor 202 may be configured to identify the value of the parameter of each item in the item list based on the information pertaining to each item in the plurality of items. In an embodiment, the processor 202 may be further configured to present the user interface on the mobile computing device 102 to display the one or more item recommendations to the first user. The processor 202 may be implemented based on a number of processor technologies known in the art. Examples of the processor 202 may include, but are not limited to, an X86-based processor, a Reduced Instruction Set Computing (RISC) processor, and/or a Complex Instruction Set Computing (CISC) processor. In an alternate embodiment, the processor 202 may be implemented as an Application-Specific Integrated Circuit (ASIC) processor specially configured for generating adaptive recommendations of relevant items.

The memory 204 may be operable to store one or more machine codes, and/or computer programs having at least one code section executable by the processor 202. The memory 204 may store the one or more sets of instructions that are executable by the processor 202, the transceiver 206, the data processor 208, the feedback controller 210, and the I/O unit 212. In an embodiment, the memory 204 may include one or more buffers (not shown). In an embodiment, the one or more buffers may be configured to temporarily store intermediate values, such as the value of the parameter of each item in the item list, the cumulative value, and the gap value, etc., identified/generated prior to/during the generation of adaptive recommendations of relevant items for the first user. Examples of some of the commonly known memory implementations may include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations for generating adaptive recommendations of relevant items for the first user. It will be apparent to a person having ordinary skill in the art that the one or more instructions stored in the memory 204 may enable the hardware of the application server 106 to perform the one or more predetermined operations, without deviating from the scope of the disclosure.

The transceiver 206 transmits/receives messages and data to/from various components, such as the mobile computing device 102 and the database server 104 of the system environment 100, over the communication network 108. In an embodiment, the transceiver 206 may be communicatively coupled to the communication network 108. In an embodiment, the transceiver 206 may be configured to receive the data associated with the first user from the one or more data sources and the feedback provided by the first user from the mobile computing device 102, over the communication network 108. In an embodiment, the transceiver 206 may be configured to transmit the one or more item recommendations and/or the updated one or more item recommendations to the mobile computing device 102, over the communication network 108. The transceiver 206 may implement one or more known technologies to support wired or wireless communication with the communication network 108. In an embodiment, the transceiver 206 may include circuitry, such as, but not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a WLAN and/or a MAN. The wireless communication may use any of a plurality of communication standards, protocols and technologies, such as: Global System for Mobile Communications (GSM), Enhanced Data GSM Evolution (EDGE), wideband code division multiple access (W-CDMA), code division multiple access (CDMA), time division multiple access (TDMA), Bluetooth, Light Fidelity (Li-Fi), Wireless Fidelity (Wi-Fi) (e.g., IEEE 802.11a, IEEE 802.11b, IEEE 802.11g and/or IEEE 802.11n), voice over Internet Protocol (VoIP), Wi-MAX, and a protocol for email, instant messaging, and/or Short Message Service (SMS).

The data processor 208 comprises suitable logic, circuitries, interfaces, and/or codes that may be configured to execute one or more sets of instructions, programs, or algorithms stored in the memory 204. The data processor 208 may be communicatively coupled to the processor 202, the memory 204, the transceiver 206, the feedback controller 210, and the I/O unit 212. The data processor 208 may be communicatively coupled to the communication network 108. In an embodiment, the data processor 208 may be configured to determine the cumulative value of the parameter associated with the item list and the gap value corresponding to the first user. Further, the data processor 208 may be configured to generate/update the one or more item recommendations for the first user. Examples of the data processor 208 may include, but are not limited to, an X86-based processor, a RISC processor, an ASIC processor, a CISC processor, and/or other processors.

A person having ordinary skill in the art will appreciate that the scope of the disclosure is not limited to realizing the data processor 208 and the processor 202 as separate entities. In an embodiment, the functionalities of the data processor 208 may be implemented within the processor 202, without departing from the spirit of the disclosure. Further, a person skilled in the art will understand that the scope of the disclosure is not limited to realizing the data processor 208 as a hardware component. In an embodiment, the data processor 208 may be implemented as a software module included in computer program code (stored in the memory 204), which may be executable by the processor 202 to perform the functionalities of the data processor 208.

The feedback controller 210 includes suitable logic, circuitry, and/or interfaces that are configured to execute the one or more sets of instructions stored in the memory 204. In an embodiment, the feedback controller 210 may be configured to process the feedback provided by the first user. In an embodiment, the feedback controller 210 may be configured to identify whether the feedback provided by the first user corresponds to negative feedback or positive feedback. In an embodiment, the feedback controller 210 may include one or more electronic circuits and/or gates that are capable of processing the feedback provided by the first user. The feedback controller 210 may be realized through various electronic components, such as, but not limited to, a SoC component, an ASIC component, or an FPGA component.

Though the feedback controller 210 is depicted as a separate entity, a person skilled in the art will appreciate that the scope of the disclosure is not limited to realizing the functionality of the feedback controller 210 by the processor 202. In an embodiment, the feedback controller 210 may be implemented within the processor 202 without departing from the spirit of the disclosure. Further, a person skilled in the art will understand that the scope of the disclosure is not limited to realizing the feedback controller 210 as a hardware component. In an embodiment, the feedback controller 210 may be implemented as a software module included in computer program code (stored in the memory 204), which may be executable by the processor 202 to perform the functionalities of the feedback controller 210.

The I/O unit 212 may comprise suitable logic, circuitry, interfaces, and/or code that may be configured to provide an output to the first user. The I/O unit 212 comprises various input and output devices that are configured to communicate with the processor 202. Examples of the input devices may include, but are not limited to, a keyboard, a mouse, a joystick, a touch screen, a microphone, a camera, and/or a docking station. Examples of the output devices may include, but are not limited to, a display screen and/or a speaker.

An embodiment of the working of the application server 106 for generating adaptive recommendations of relevant items has been explained later in FIG. 3.

FIG. 3 depicts a flowchart that illustrates a method for generating adaptive recommendations of relevant items, in accordance with at least one embodiment. FIG. 3 is described in conjunction with FIG. 1 and FIG. 2. With reference to FIG. 3, there is shown a flowchart 300 that illustrates a method for generating adaptive recommendations of relevant items. A person having ordinary skill in the art will understand that the examples, as described in FIG. 3, are for illustrative purpose and should not be construed to limit the scope of the disclosure. The method starts at step 302 and proceeds to step 304.

At step 304, the data associated with the first user is received from the one or more data sources over the communication network 108. In an embodiment, the processor 202, in conjunction with the transceiver 206, may be configured to receive the data associated with the first user from the one or more data sources over the communication network 108. In an embodiment, the data associated with the first user may comprise an item list associated with the first user and the information of the plurality of second users connected to the first user in the social networking graph.

In an embodiment, the item list associated with the first user may comprise at least one item from the plurality of items. The processor 202, in conjunction with the transceiver 206, may be configured to access the one or more data sources, such as the local memory of the mobile computing device 102 or the database server 104, for retrieving the item list associated with the first user. In an embodiment, the first user may have stored the item list, comprising items to be purchased in future, in the local memory of the mobile computing device 102. In another embodiment, the first user may have stored the item list in the local memory of the mobile computing device 102 at the time of purchasing the items. In another embodiment, the first user may have not stored the item list in either the local memory of the mobile computing device 102 or the database server 104. In this scenario, the processor 202 may retrieve the purchase history of the first user from the mobile computing device 102 to extract the item list associated with the first user from the purchase history of the first user. In an embodiment, the item list of first user may be associated with a first time period.

In an exemplary scenario, the first user purchases “3” food items, such as “1 kg apples,” “1 kg potatoes,” and “1 kg mangoes,” almost every week. Further, the first user makes the purchase transactions by utilizing the mobile computing device 102. The processor 202 may retrieve the purchase history of the first user from the local memory of the mobile computing device 102. Thereafter, the processor 202 may utilize the purchase history to identify a purchase trend of the first user. The processor 202 may determine that the first user has purchased “3” food items every week in the past. In such a case, the processor 202 may determine that the “3” food items, such as “1 kg apples,” “1 kg potatoes,” and “1 kg mangoes,” purchased by the first user on a periodic basis (i.e., every week) constitute the food item list (i.e., the item list) associated with the first user. Further, the food item list is associated with the first time period “one week.” In other exemplary scenarios, the item list may correspond to a list of training items, or a list of service items.

In another exemplary scenario, the first user purchases “3” food items, such as “1 kg mangoes” each month, “1 kg apples” each week, and “1 kg potatoes” every day for consumption. Further, the first user makes the purchase transactions by utilizing the mobile computing device 102. The processor 202 may retrieve the purchase history of the first user from the local memory of the mobile computing device 102. Thereafter, the processor 202 may utilize the purchase history to identify a purchase trend of the first user. Thereafter, the a processor 202 may determine the item list for a first time period of “one week” based on pro-rating, such as “¼ kg mangoes,” “1 kg apples,” and “7 kg potatoes” every week.

Further, each item in the plurality of items may be associated with the parameter. For example, each food item in the food item list may be associated with the parameter, such as nutrition. Each training item in the training item list may be associated with the parameter, such as skill-set. Similarly, each service item in the service item list may be associated with the parameter, such as quality of service.

A person having ordinary skill in the art will understand that the abovementioned example is for illustrative purpose and should not be construed to limit the scope of the disclosure.

In an embodiment, the processor 202 may be configured to receive the information of the plurality of second users through the social networking graph. In an embodiment, the processor 202 may query the database server 104 to retrieve the social networking graph. In another embodiment, when the social networking graph is not stored in the database server 104, the processor 202 may retrieve the social networking graph by accessing the one or more social networking sites. The social networking graph may represent connections between the plurality of users who are registered on the one or more social networking sites.

In an exemplary scenario, the processor 202 may retrieve the social networking graph, G=(U,E) from the database server 104, where U represents a set of nodes and E represents a set of undirected weighted edges between one or more pairs of nodes in the set of nodes U. Further, each node in the set of nodes U represents a registered user among the plurality of users, and each edge eᵤ_{₁}_{,u}_{₂} in the set of undirected weighted edges E represents a direct connection between a node u₁ and a node u₂. Further, weight tᵤ_{₁}_{,u}_{₂} of an undirected weighted edge eᵤ_{₁}_{,u}_{₂} is based on a trust score between the user u₁ and the user u₂. In an embodiment, the trust score may be determined based on a frequency of interaction between the user u₁ and the user u₂. Further, the nodes in the set of nodes U, corresponding to users with no direct connection, are not connected by any undirected weighted edge.

A person having ordinary skill in the art will understand that the abovementioned exemplary scenario is for illustrative purpose and should not be construed to limit the scope of the disclosure.

After the retrieval of the social networking graph G, the processor 202 may be configured to identify the one or more connections (i.e., direct connections and indirect connections) of the first user in the social networking graph. The one or more connections (i.e., the direct connections and the indirect connections) of the first user may correspond to the plurality of second users. For example, a first user u₁ may be directly connected to users u₂ and u₃, indirectly connected to user u₄, and not connected at all to users u₅ and u₆ in the social networking graph G. Thus, only the users u₂, u₃, and u₄ may correspond to the plurality of second users. Further, the processor 202 may be configured to retrieve the one or more social profiles of each of the plurality of second users from the one or more social networking sites. In an embodiment, the processor 202 may be configured to transmit an access request to mobile computing devices associated with the plurality of second users for acquiring permission to retrieve the one or more social profiles of each of the plurality of second users from the one or more social networking sites.

At step 306, the cumulative value of the parameter associated with the item list is determined. In an embodiment, the data processor 208, in conjunction with the processor 202, may be configured to determine the cumulative value of the parameter associated with the item list. Further, the processor 202 may be configured to associate the determined cumulative value of the parameter with the first time period associated with the item list.

Before determining the cumulative value of the parameter associated with the item list, the processor 202 may be configured to retrieve the information pertaining to each item in the plurality of items from the database server 104. In an embodiment, the information may comprise the value of the parameter of each item in the plurality of items. Thereafter, based on the retrieved information, the processor 202 may be configured to identify the value of the parameter of each item in the item list of the first user. For example, the processor 202 may be configured to identify the nutrition value of each food item, such as “1 kg apples,” “1 kg potatoes,” and “1 kg mangoes,” in the food item list based on the retrieved information.

In an exemplary scenario, Table 1, shown below illustrates the nutrition value of each food item in the food item list associated with the first user.

TABLE 1
Nutrition value of each food item in an item list.

| | | Fat | Sugar | Protein |
|---|---|---|---|---|
| Food item | Calories/kg | content/kg | content/kg | content/kg |
| 1 kg Apples | 520 | 0 | 100 g | 4 g |
| 1 kg Potatoes | 742.5 | 1 g | 6.75 g | 20.25 g |
| 1 kg Mangoes | 599 | 3.86 g | 137 g | 8.33 g |

A person having ordinary skill in the art will understand that the abovementioned exemplary scenario is for illustrative purpose and should not be construed to limit the scope of the disclosure. Further, the nutrition value of each food item in the abovementioned Table is normalized to unit mass (1 kg) based on nutrition value associated with per serving of each food item.

Thereafter, the data processor 208 may be configured to determine the cumulative value of the parameter associated with the item list. In an embodiment, the data processor 208 may be configured to aggregate the value of the parameter of each item in the item list to determine the cumulative value of the item list.

In accordance with the exemplary scenario, with reference to Table 1, the data processor 208 may be configured to aggregate the nutrition value of each food item, such as “1 kg apples,” “1 kg potatoes,” and “1 kg mangoes,” in the food item list to determine the cumulative nutrition value of the food item list. The data processor 208 may be configured to add the calorie content of the “1 kg apples,” “1 kg potatoes,” and “1 kg mangoes” in the item list to determine the cumulative calorie content (i.e., 1861.5 calories) of the food item list. Similarly, the data processor 208 may be configured to determine the cumulative fat content (i.e., 4.86 g), the cumulative sugar content (i.e., 445.75 g), and the cumulative protein content (i.e., 32.58 g) of the food item list. Accordingly, the data processor 208 may be configured to determine the cumulative nutrition value of the item list, based on the aggregation of the cumulative calories, cumulative fats, cumulative sugar, and cumulative proteins (i.e., 1861.5 calories, 4.86 g, 445.75 g, and 32.58 g). Further, the cumulative nutrition value is associated with the first time period “one week” corresponding to the food item list.

A person having ordinary skill in the art will understand that the abovementioned exemplary scenario is for illustrative purpose and should not be construed to limit the scope of the disclosure. Further, in other scenarios, when the item list corresponds to training item list, or the service item list, the data processor 208 may be configured to aggregate the skill-set value, or the quality of service value, respectively, to determine the cumulative value associated with the item list.

At step 308, the gap value, corresponding to the first user, is determined based on the cumulative value of the parameter associated with the item list and the reference value of the parameter corresponding to the first user. In an embodiment, the data processor 208, in conjunction with the processor 202, may be configured to determine the gap value, corresponding to the first user, based on the cumulative value of the parameter associated with the item list and the reference value of the parameter corresponding to the first user.

Before determining the gap value, the processor 202 may be configured to retrieve the profile information of the first user from the local memory of the mobile computing device 102. Further, the processor 202 may be configured to extract the reference value of the parameter corresponding to the first user from the profile information. In an embodiment, the reference value of the parameter may be associated with a second time period. In an embodiment, the second time period may be same as the first time period. In another scenario, when the first time period associated with the cumulative value of the parameter is not same as the second time period, the processor 202 may be configured to normalize the cumulative value of the parameter, such that the second time period associated with the normalized cumulative value of the parameter is equal to the first time period.

In an exemplary scenario, the processor 202 may determine the reference value, such as the per day reference nutrition value, from the RDA goal in the medical details of the first user. Thereafter, the processor 202 may normalize the per day reference nutrition value to per week reference nutrition based on the first time period “one week.” For example, the per week reference nutrition value required by the first user may be represented as reference calories, reference fats, reference sugar, and reference proteins, such as 2000 calories, 5 g, 500 g, and 40 g.

A person having ordinary skill in the art will understand that the abovementioned examples are for illustrative purpose and should not be construed to limit the scope of the disclosure.

Similarly, in other scenarios, the processor 202 may determine the reference skill-set value, or the reference quality of service value, based on the profile information of the first user.

After the extraction of the reference value corresponding to the first user, the data processor 208 may be configured to determine the gap value corresponding to the first user. In an embodiment, the gap value corresponding to the first user may represent a difference in the cumulative value of the parameter associated with the item list and the reference value of the parameter corresponding to the first user.

In an exemplary scenario, the gap value may depict a difference between the nutrition value provided by the weekly food item list and the weekly reference nutrition value required by the first user. Further, the gap may signify that the current food item list is incapable of addressing the weekly required nutrition needs of the first user. For example, when the weekly cumulative nutrition value is 1861.5 calories, 4.86 g, 445.75 g, and 32.58 g, and the weekly reference nutrition value is 2000 calories, 5 g, 500 g, and 40 g, the data processor 208 may determine the gap value as a gap vector (138.5 calories, 0.14 g, 55.25 g, and 7.42 g) corresponding to the first user. In another example, when the weekly cumulative nutrition value is 1861.5 calories, 4.86 g, 445.75 g, and 32.58 g, and the weekly reference nutrition value is 1500 calories, 4.50 g, 500 g, and 30 g, the data processor 208 may determine the gap value as (−361.5 calories, −0.36 g, 55.25 g, and −2.58 g) corresponding to the first user. The negative sign may indicate that the nutrition intake is more than the reference nutrition value. Further, the gap value may be associated with the first time period, such as “one week.”

In another exemplary scenario, the gap value may depict a difference between the skill-set value of the training item list and the reference skill-set value required, from the first user, by an organization in which the first user is an employee. Further, the gap value may signify that the current training item list is incapable of enhancing the required professional skills of the first user as demanded by the organization for the current job profile of the first user.

In another exemplary scenario, the gap value may depict a difference between the quality of service value of the service item list and the reference quality of service value associated with the first user. Further, the gap value may signify that the current service item list is incapable of fulfilling the required quality of service expectations of the first user.

A person having ordinary skill in the art will understand that the abovementioned exemplary scenarios are for illustrative purpose and should not be construed to limit the scope of the disclosure.

At step 310, the one or more item recommendations are generated based on the gap value of the parameter corresponding to the first user with respect to the reference value of the parameter and the one or more association factors of the plurality of second users with one or both of each item in the plurality of items and the first user. In an embodiment, the data processor 208, in conjunction with the processor 202, may be configured to generate the one or more item recommendations based on the gap value of the parameter corresponding to the first user with respect to the reference value of the parameter and the one or more association factors of the plurality of second users with one or both of each item in the plurality of items and the first user.

Before generating the one or more item recommendations, the data processor 208 may be configured to determine a first score and a second score for each item in the plurality of items.

In an embodiment, the data processor 208 may be configured to determine the first score for each item in the plurality of items. In an embodiment, the data processor 208 may be configured to determine the first score for each item in the plurality of items based on the determined gap value corresponding to the first user and the value of the parameter associated with the corresponding item in the plurality of items. The data processor 208 may utilize one or more similarity measuring techniques known in the art for determining the first score for the item. In an embodiment, the first score for an item may be representative of a similarity between the value of the parameter of the item and the gap value corresponding to the first user. Further, the first score for the item may depict how efficiently the item may address the gap value corresponding to the first user. In an embodiment, the data processor 208 may further utilize the profile information of the first user to determine the first score.

In an exemplary scenario, the data processor 208 may be configured to determine the first score ItemSim(gᵤ_{₁}, Iₖ) for each food item Iₖ in the plurality of food items. The data processor 208 may determine the first score ItemSim(gᵤ_{₁}, Iₖ) for each food item Iₖ based on the gap value gᵤ_{₁} corresponding to the first user u₁ and the nutrition value of the corresponding food item Iₖ. An example of the gap value gᵤ_{₁} may be (138.5 calories, 0.14 g, 55.25 g, and 7.42 g) such that the gap value gᵤ_{₁} may have all the elements, such as calories, fats, sugar, and proteins, greater than zero. Another example of the gap value gᵤ_{₁} may be (−361.5 calories, −0.36 g, 55.25 g, and −2.58 g) such that some elements, such as calories, fats, and proteins, of the gap value gᵤ_{₁} may be less than zero. Further, the data processor 208 may utilize the profile information of the first user u₁ to determine the first score ItemSim(gᵤ_{₁},Iₖ) for each food item Iₖ in the plurality of food items. Table 2, as shown below, illustrates the nutrition value of each food tem in the plurality of food items.

TABLE 2
Nutrition value of each food item in the plurality of food items.

| | | Fat | Sugar | Proteins |
|---|---|---|---|---|
| Food item | Calories/kg | content/kg | content/kg | content/kg |
| 1 kg Apples | 520 | 0 | 100 g | 4 g |
| 1 kg Potatoes | 742.5 | 1 g | 6.75 g | 20.25 g |
| 1 kg Mangoes | 599 | 3.86 g | 137 g | 8.33 g |
| 1 kg cabbages | 261 | 0 | 27.625 g | 13 g |
| 1 kg papayas | 426 | 2.54 g | 76.433 g | 4.46 g |
| 1 kg bananas | 890 | 3.4 g | 119 g | 11 g |
| 1 kg grapes | 621 | 30 g | 150 g | 6 g |
| 1 kg watermelon | 304 | 1.5 g | 61 g | 6.1 g |
| 1 kg eggplant | 244 | 1.22 g | 26.6 g | 10.24 g |

In accordance with the example, with reference to Table 2, the data processor 208 may determine the first score ItemSim(gᵤ_{₁},Iₖ), such as 0.56, 0.32, 0.35, 0.89, 0.82, 0.45, 0.76, 0.67, and 0.87, for each food item Iₖ in the plurality of food items, when the gap value gᵤ_{₁} is 138.5 calories, 0.14 g, 55.25 g, and 7.42 g. Similarly, the data processor 208 may determine the first score ItemSim(gᵤ_{₁},Iₖ), such as 0.58, 0.32, 0.05, 0.54, 0.82, 0.65, 0.76, 0.67, and 0.87, for each food item Iₖ in the plurality of food items when the gap value gᵤ_{₁} is −361.5 calories, −0.36 g, 55.25 g, and −2.58 g. In a scenario, when the first user u₁ is allergic to a food item I₉, such as eggplant, the data processor 208 may determine the first score ItemSim(gᵤ_{₁},I₉) for eggplant as “0.” In another scenario, when the first user is a diabetes patient, the data processor 208 may determine a very low first score for sugar rich food items, such as “grapes,” “bananas,” “mangoes,” and/or the like, among the plurality of food items.

A person having ordinary skill in the art will understand that the scope of the disclosure is not limited to determining the first score for each food item in the plurality of food items. In another embodiment, the data processor 208 may be configured to determine the first score for training item, or service item in the plurality of training items, or service items, respectively, without deviating from the scope of the disclosure.

Thereafter, the data processor 208 may be configured to determine the second score for each item in the plurality of items. In an embodiment, the data processor 208 may be configured to determine the second score for each item in the plurality of items based on the one or more association factors of the plurality of second users with one or both of: the item in the plurality of items and the first user. In an embodiment, the one or more association factors may comprise the first association factor and the second association factor.

In an embodiment, the data processor 208 may be configured to determine the second score for each item in the plurality of items based on the first association factor of the plurality of second users with the corresponding item in the plurality of items. In an embodiment, the first association factor for an item in the plurality of items may be based on the affinity score of the plurality of second users with the item in the plurality of items. The data processor 208 may utilize the social profiles of each of the plurality of second users to determine the affinity score of the plurality of second users with each item in the plurality of items. For example, if a second user has liked or shared a post associated with a food item in his/her social profile, the affinity score of the corresponding user for the corresponding food item is higher than that associated with another second user who has posted a negative review for the corresponding food item. The data processor 208 may further utilize the purchase history of each second user among the plurality of second users to determine the affinity score of the plurality of second users with each item in the plurality of items. For example, if a second user purchases an item on periodic basis, the affinity score of the corresponding second user for the corresponding item is higher than that of another second user who purchases the item very rarely, such as once in a year.

In an embodiment, the data processor 208 may be further configured to determine the second score for each item in the plurality of items based on the second association factor of the plurality of second users with the first user. In an embodiment, the second association factor for an item in the plurality of items may be based on the trust score between the plurality of second users and the first user. The data processor 208 may utilize the social networking graph to determine the trust score between the plurality of second users and the first user. In an embodiment the data processor 208 may be configured to determine the trust score between a second user uₙ and the first user u₁ based on the weight tᵤ_{₁}_{,u}_{ₙ} of the undirected weighted edge eᵤ_{₁}ᵤ_{ₙ} between the node representing the first user u₁ and the node representing a second user uₙ in the social networking graph G. For example, if a second user interacts with the first user daily through the one or more social networking daily websites, the trust score between the second user and the first user is higher than that associated with another second user that interacts very rarely with the first user. Further, the trust score between the first user and the directly connected second users may be higher than that with the indirectly connected second users. Also, the trust score for the second users that have similar profile information or the social profile as of the first user may be higher than that of the second users that have dissimilar profile information or the social profiles.

In an exemplary scenario, the data processor 208 may utilize equation (1), as shown below, for determining the second score for each item in the plurality of items:

second score(Iₖ)=ΣAffinity score₍ᵤ_{ₙ}_{,I}_{ₖ}₎*Trust score₍ᵤ_{ₙ}_{,u}_{₁}₎ (1)

where,

Affinity score₍ᵤ_{ₙ}_{,I}_{ₖ}₎ represents the first association factor of the plurality of second users with the corresponding item Iₖ in the plurality of items. The first association factor is based on the affinity score of each of the plurality of second users uₙ with the corresponding item Iₖ in the plurality of items; and

Trust score₍ᵤ_{ₙ}_{,u}_{₁}₎ represents the second association factor of the plurality of second users with the first user u₁. The second association factor is based on the trust score between each of the plurality of second users uₙ and the first user u₁.

A person having ordinary skill in the art will understand that the abovementioned exemplary scenario is for illustrative purpose and should not be construed to limit the scope of the disclosure.

After the determination of the first score and the second score, the data processor 208 may be configured to generate the one or more item recommendations. In an embodiment, the data processor 208 may be configured to add the first score and the second score for each item in the plurality of items. The data processor 208 may utilize equation (2), as shown below, to determine the sum SocItemSim (gᵤ_{₁},Iₖ) of the first score and the second score for each item Iₖ among the plurality of items:

SocItemSim(gᵤ_{₁},Iₖ)=ItemSim(gᵤ_{₁},Iₖ)+w₁ΣAffinity score₍ᵤ_{ₙ}_{,I}_{ₖ}₎*Trust score₍ᵤ_{ₙ}_{,u}_{₁}₎ (2)

where,

w₁ represents a predetermined weight associated with the second score, such that the second score may correspond to a weighted score with w₁>0.

Based on the equation (2), the data processor 208 may be configured to identify one or more items that have the highest sum SocItemSim (gᵤ_{₁},Iₖ). In another embodiment, the data processor 208 may be configured to identify a predetermined count (“top-k”) of items with the highest sum SocItemSim (gᵤ_{₁},Iₖ).

In an embodiment, the data processor 208 may be further configured to identify one or more second users among the plurality of second users associated with one or more items with the highest sum. In a scenario, for an identified item with the highest sum, the data processor 208 may be configured to identify a second user that has a high affinity score with the identified item and has a high trust score with the first user. For example, the data processor 208 may identify a food item I₃ with the highest sum SocItemSim (gᵤ_{₁},I₃). Further, the data processor 208 identifies that a second user u₂ has the affinity score “0.68,” another second user u₃ has the affinity score “0.65,” and yet another second user u₄ has the affinity score “0.23,” with the identified food item I₃. Further, the data processor 208 identifies that the second users u₂, u₃, and u₄ have trust scores “0.78,” “0.87,” “0.90,” respectively, with the first user. Thus, the data processor 208 may identify the second user u₃ to be associated with the food item I₃.

A person having ordinary skill in the art will understand that the scope of the disclosure is not limited to the generation of the one or more item recommendations based on the first score and the second score.

In another embodiment, the data processor 208 may be configured to further filter the identified one or more items. For filtering the identified one or more items, the data processor 208, in conjunction with the transceiver 206, may be configured to transmit information, pertaining to the identified one or more items that have the highest sum SocItemSim (gᵤ_{₁},Iₖ), to other mobile computing devices (not shown) associated with the plurality of second users through a user interface. Further, the plurality of second users may utilize the user interface for casting votes for the identified one or more items based on the transmitted information. Thereafter, the data processor 208 may be configured to receive the voting responses of the plurality of second users. In an embodiment, the data processor 208 may be configured to further perform polling and filter the one or more items based on the voting responses. For example, the data processor 208 may be configured to discard an identified food item that has minimum votes from the plurality of second users.

In an embodiment, the data processor 208 may be configured to generate the one or more item recommendations by utilizing the one or more identified items and the identified one or more second users associated with the corresponding one or more items. In an embodiment, each item recommendation of the generated one or more item recommendations may comprise details of the identified one or more items from the plurality of items. For example, each food item recommendation of the one or more food item recommendations may comprise details, such as serving size and/or count of servings, of the identified one or more food items associated with the corresponding food item recommendation.

In an embodiment, the data processor 208 may be configured to generate the one or more item recommendations, such that the identified item, in an item recommendation, may be recommended to be added to the item list of the first user. For example, in a food item recommendation, such as “Addition of 530 g of eggplant to your weekly food item list will fulfill your per week required calorie intake,” “530 g of eggplant” is recommended to be added to the food item list. In another embodiment, the data processor 208 may be configured to further generate the one or more item recommendations, such that the identified item, in an item recommendation, may be recommended to replace an existing item in the item list of the first user. In an embodiment, the data processor 208 may be configured to generate such an item recommendation when the gap value comprises a negative element. For example, in a food item recommendation, such as “Replacing 1 kg of mangoes with 530 g of eggplant in your weekly food item list will fulfill your per week required nutrition value,” “530 g of eggplant” is recommended to replace “1 kg of mangoes” in the food item list.

A person having ordinary skill in the art will understand that the abovementioned example is for illustrative purpose and should not be construed to limit the scope of the disclosure.

In an embodiment, each item recommendation of the one or more item recommendations may further comprise details of the identified one or more second users, who may be associated with the identified one or more items in the corresponding item recommendation, along with the details of the identified one or more items. For example, a food item recommendation, such as “Your friend B gets her proteins from cabbage, you may add 480 g of cabbage in your weekly food item list to fulfill your weekly nutrition requirement,” may comprise details pertaining to the identified second user, such as “user B,” associated with the corresponding identified food item, such as “530 g of cabbage.”

A person having ordinary skill in the art will understand that the abovementioned examples are for illustrative purpose and the scope of the disclosure is not limited to the generation of one or more food item recommendations. In another embodiment, the data processor 208 may be configured to generate one or more training item recommendations, or service item recommendations, without deviating from the scope of the disclosure.

At step 312, the one or more item recommendations are transmitted to the mobile computing device 102 associated with the first user over the communication network 108. In an embodiment, the processor 202, in conjunction with the transceiver 206, may be configured to transmit the one or more item recommendations to the mobile computing device 102 associated with the first user over the communication network 108. In an embodiment, the data processor 208 may be configured to present the one or more item recommendations to the first user through the user interface displayed on the mobile computing device 102.

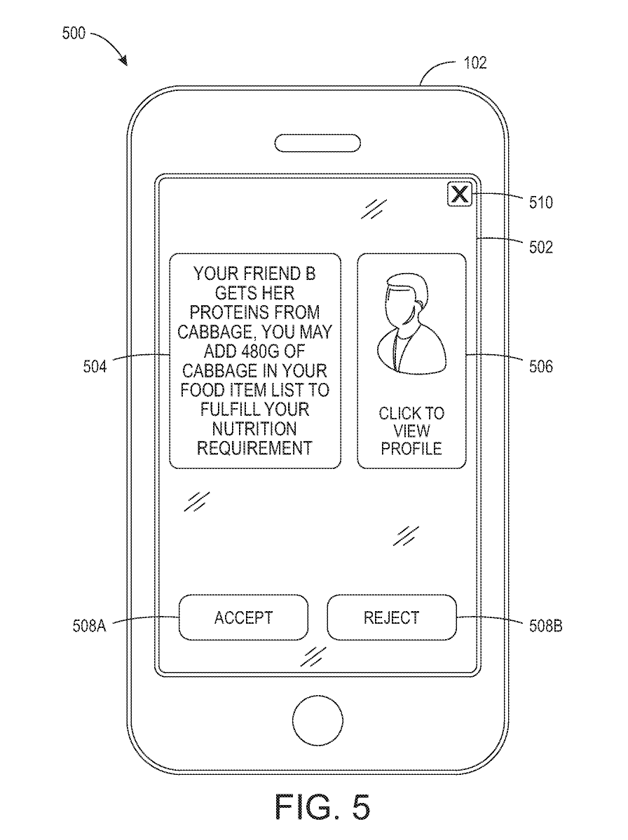

In an embodiment, the first user may utilize the user interface to provide the feedback. For example, the first user may select or reject an item recommendation from the one or more item recommendations. In another embodiment, the first user may not provide the feedback by utilizing the user interface. In such a case, the first user may provide the feedback by updating the item list for next purchase, such that the updated item list comprises the one or more items constituted by at least one item recommendation of the one or more item recommendations. For example, the first user may update the previous food item list for the next week (i.e., “1 kg apples,” “1 kg potatoes,” and “1 kg mangoes”) to include “530 g of cabbage” based on a food item recommendation. In an alternate embodiment, the first user may not provide any feedback for the one or more item recommendations. An exemplary user interface for displaying item recommendations to the first user on the mobile computing device 102 has been illustrated in FIG. 5, as described later.

A person having ordinary skill in the art will understand that the abovementioned example is for illustrative purpose and should not be construed to limit the scope of the disclosure.

At step 314, a check is performed to determine whether the first user has provided any feedback. In an embodiment, the feedback controller 210, in conjunction with the processor 202, may be configured to perform the check to determine whether the first user has provided any feedback. In an embodiment, the selection or rejection of any recommendation of the one or more item recommendations by the first user may correspond to the feedback. In other words, the first user may provide the explicit feedback on the one or more item recommendations. Thus, the feedback controller 210 may be configured to monitor the response of the first user on each of the one or more item recommendations. In another embodiment, the first user may not provide the explicit feedback. In such a case, the feedback controller 210 may determine the response (i.e., the implicit feedback) of the first user by further identifying the updated item list based on the purchase history of the first user. When the processor 202 determines that the first user has provided the implicit/explicit feedback, control passes to step 316. Else, the one or more item recommendations remain unchanged and the control passes to end step 318.

At step 316, the one or more item recommendations are updated based on the feedback provided by the first user. In an embodiment, the data processor 208, in conjunction with the processor 202, may be configured to update the item recommendations based on the feedback provided by the first user. In an embodiment, the data processor 208 may be configured to determine a third score based on the feedback of the first user.

Before determining the third score, the feedback controller 210 may be configured to process the feedback (i.e., the explicit feedback) received from the mobile computing device 102 over the communication network 108. Based on the processing, the feedback controller 210 may determine whether the feedback corresponds to the positive feedback or the negative feedback. For example, when the first user selects a food item recommendation from the one or more food item recommendations, the selection of the food item recommendation by the first user may correspond to the positive feedback. In another scenario, the first user may reject a food item recommendation from the one or more food item recommendations. In such a case, the rejection of the food item recommendation may correspond to the negative feedback.

Thereafter, based on the feedback, the data processor 208 may be configured to determine the third score for each of the plurality of items. In an embodiment, the data processor 208 may be configured to determine a positive third score when the feedback is positive. The data processor 208 may be configured to determine a negative third score, when the feedback is negative. For the determination of the third score, the data processor 208 may be configured to determine an extent of similarity between each item in the plurality of items and the item constituted by the item recommendation associated with the feedback by utilizing one or more similarity measuring techniques known in the art. Thereafter, the data processor 208 may be configured to determine the third score for each of the plurality of items based on the extent of similarity. Thus, the data processor 208 may be configured to determine a higher third score for a first item that is very similar (i.e., in terms of the value of the parameter) to the item in the selected item recommendation than for a second item that is very less similar to the item in the selected item recommendation.

Thereafter, the data processor 208 may be configured to update the one or more item recommendations based on the first score, the second score and the third score. The data processor 208 may utilize equation (3), as shown below, to determine a new sum of the first score, the second score, and the third score to generate the updated one or more item recommendations:

SocItemSim(gᵤ_{₁},Iₖ)=ItemSim(gᵤ_{₁},Iₖ)+w₁ΣAffinity score₍ᵤ_{ₙ}_{,I}_{ₖ}₎*Trust score₍ᵤ_{ₙ}_{,u}_{₁}₎+w₂ third score(gᵤ_{₁},Iₖ) (3)

where,

w₂ represents a predetermined weight associated with the third score, such that the third score corresponds to a weighted score with w₂>0; and

third score (gᵤ_{₁},Iₖ) represents the third score for each item in the plurality of items that is determined based on the feedback provided by the first user.

In another embodiment, when the feedback corresponds to an update of the item list (i.e., the implicit feedback), the data processor 208, in conjunction with the processor 202, may be configured to execute the entire recommendation process again for generating the updated one or more item recommendations based on the updated item list. Thereafter, control passes to step 312.

In an embodiment, based on the updated item list, the data processor 208 may determine that the gap value corresponding to the first user is nearly “0” or less than a pre-defined threshold value. In such a case, the data processor 208 may be configured to transmit, the one or more item recommendations to the plurality of second users. The one or more item recommendations in such a case may comprise information of the first user and information pertaining to the items in the updated item list of the first user. For example, “Your friend “A” has achieved 100% RDA by using 1 kg apples, 1 kg potatoes, 1 kg mangoes, and 530 g eggplant per week.”

A person having ordinary skill in the art will understand that the abovementioned example is for illustrative purpose and should not be construed to limit the scope of the disclosure.

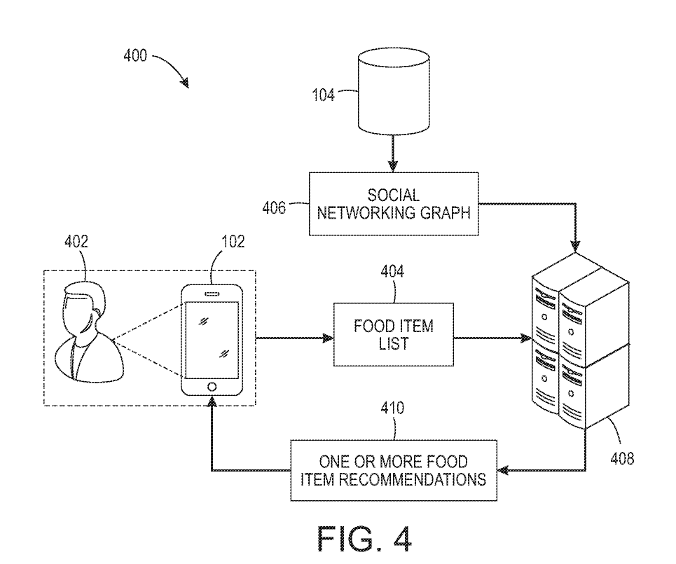

FIG. 4 is a block diagram that illustrates an exemplary scenario for generating adaptive recommendations of relevant food items, in accordance with at least one embodiment. FIG. 4 is described in conjunction with FIGS. 1-3. With reference to FIG. 4, there is shown an exemplary scenario 400 for generating adaptive recommendations of relevant food items for a first user 402.

The first user 402 may store a list of food items (i.e., a food item list 404) that he/she wants to purchase, for consumption during next week, in the mobile computing device 102. The food item list 404 may comprise details pertaining to the quantity associated with corresponding food items which are to be consumed during the next week. In an embodiment, the food item list 404 may comprise food items for the weekly consumption of the first user only. In another embodiment, the food item list 404 may comprise food items for the weekly consumption of the first user's family. The family may include a plurality of first users. In this scenario, the first user 402 may specify a count of first users in the plurality of first users along with their profile information.

Further, the database server 104 may store a social networking graph 406 associated with one or more social networking websites. The social networking graph 406 may represent various connections (i.e., direct connections and indirect connections) among a plurality of users registered on the one or more social networking websites. The database server 104 may further store information pertaining to a plurality of food items. The information may comprise the value of the parameter (i.e., nutrition value) associated with each of the plurality of food items.

A recommendation server 408, such as the application server 106, may transmit an access request to the mobile computing device 102 for acquiring a permission to access the local memory of the mobile computing device 102. Thereafter, the recommendation server 408 may retrieve the food item list 404 and profile information of the first user 402 stored in the local memory of the mobile computing device 102. Further, the recommendation server 408 may retrieve the social networking graph 406 from the database server 104. The recommendation server 408 may further retrieve the information pertaining to the plurality of food items from the database server 104.

Thereafter, the recommendation server 408 may utilize the social networking graph 406 to identify a plurality of second users that are connected (directly or indirectly) to the first user 402 in the social networking graph 406. Further, the recommendation server 408 may retrieve social profiles of the plurality of second users from the one or more social networking websites. Further, based on the information pertaining to the plurality of food items, the recommendation server 408 may identify the nutrition value associated with each food item in the food item list 404.

Thereafter, the recommendation server 408 may determine a cumulative nutrition value associated with the food item list 404 based on the nutrition value associated with each food item in the food item list 404. Further, the recommendation server 408 may identify a weekly reference nutrition value based on an RDA goal in the profile information of the first user 402. Thereafter, the recommendation server 408 may determine a gap value between the weekly reference nutrition value required by the first user 402 and the cumulative nutrition value associated with the food item list 404.

A person having ordinary skill in the art will understand that when the food item list 404 is for the plurality of first users, the recommendation server 408 may identify a weekly reference nutrition value based on an RDA goal in aggregated profile information of the plurality of first users.

Thereafter, the recommendation server 408 may determine the first score and the second score for each food item in the plurality of food items. The recommendation server 408 may determine the first score for each food item based on the gap value and the nutrition value associated with the corresponding food item. Further, the recommendation server 408 may determine the second score for each food item based on the one or more association factors of the plurality of second users with one or both of the corresponding food item and the first user 402. The one or more association factors may comprise the first association factor and the second association factor. The first association factor for a food item may be based on the affinity score of the plurality of second users with the food item. The recommendation server 408 may determine the first association factor for each food item by utilizing the social profile or a purchase history of each of the plurality of second users. The second association factor for a food item may be based on the trust score between the plurality of second users and the first user 402. The recommendation server 408 may determine the second association factor for each food item by utilizing the social networking graph 406 and the social profile of each of the plurality of second users.

Thereafter, based on the first score and the second score, the recommendation server 408 may identify one or more food items from the plurality of food items that may be suitable for addressing the gap value corresponding to the first user 402. Further, the recommendation server 408 may identify one or more second users that are associated with the identified one or more food items. Thereafter, the recommendation server 408 may generate one or more food item recommendations 410, such that a food item recommendation may comprise details, such as corresponding nutrition values, of the one or more food items and/or details of the identified one or more second users that are associated with the one or more food items in the corresponding food item recommendation.

Thereafter, the recommendation server 408 may transmit the one or more food item recommendations 410 to the mobile computing device 102. The one or more food item recommendations 410 may be presented to the first user 402 through a user interface. In a scenario, the first user 402 may provide an implicit or explicit feedback for the one or more food item recommendations 410. In another scenario, the first user 402 may not provide any feedback at all for the one or more food item recommendations 410. When the first user 402 provides the feedback, the recommendation server 408 may determine a third score for each food item in the plurality of food items. Further, the recommendation server 408 may update the one or more food item recommendations 410 based on the third score (i.e., the feedback) and transmit the updated one or more food item recommendations 410 to the mobile computing device 102.

A person having ordinary skill in the art will understand that when the food item list 404 is for the plurality of first users, the recommendation server 408 may generate the one or more food item recommendations for the plurality of first users. Further, it may be noted that the exemplary scenario 400 for generating adaptive recommendations of relevant food items is merely for representative purpose applicable in food industry, and should not be construed to limit of the disclosure. Notwithstanding, the generation of adaptive recommendations of relevant items may be extended to other application areas, such as organizational training, service industry, and the like, without deviating from the scope of the disclosure.

FIG. 5 is a block diagram that illustrates an exemplary scenario for presenting one or more item recommendations to a user on a mobile computing device, in accordance with at least one embodiment. FIG. 5 is described in conjunction with FIG. 1 to FIG. 3.

With reference to FIG. 5, there is shown an exemplary scenario 500 for presenting a user interface 502 for displaying item recommendations to the first user on the mobile computing device 102. In an embodiment, the user interface 502 may comprise a first section 504 that displays the item recommendation to the first user. In another embodiment, when the item recommendation comprises details of a second user along with the details of the one or more items, the user interface 502 may further comprise a second section 506 that presents profile information of the second user, when the first user clicks on it. The user interface 502 further comprises a first tab 508A “ACCEPT” and a second tab 508B “REJECT.” The first user may click on the first tab 508A “ACCEPT” to provide the positive feedback or on the second tab 508B “REJECT” to provide the negative feedback. The first user may click on a close button 510, when the first user may not want to provide any feedback.

A person having ordinary skill in the art will understand that the scope of the abovementioned exemplary scenario is for illustrative purpose and should not be construed to limit the scope of the disclosure.

The disclosed embodiments encompass numerous advantages. The disclosure provides a method and a system for data processing by a computing device for generating adaptive recommendations of relevant items. The disclosed method utilizes personalized information, such as a personalized diet plan, of a user to recommend items that are relevant to the user. The disclosed method identifies the relevant items that address gaps, such as gaps in nutrition intake, in the user's fixed reference value, such as the personalized diet plan. Further, the disclosed method utilizes the social network (such as a social media network) of the user while recommending the relevant items which makes the item recommendations more appealing and in turn increases the likelihood of acceptance of the item recommendations. The disclosed method further utilizes a dynamic approach to update the item recommendations in real-time based on a feedback provided by the user. The disclosed method may be utilized to further generate adaptive item recommendations for a group of other users that has similar gap values as of the user. The disclosed method may be utilized by any user/customer who wants to receive recommendations of relevant items, such as healthier food items.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for data processing by a computing device for generating adaptive recommendations of relevant items have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method of data processing by a computing device for generating adaptive recommendations of relevant items, the method comprising:
receiving, by one or more transceivers in the computing device, data associated with a first user from one or more data sources over a communication network, wherein the data comprises an item list associated with the first user and information of a plurality of second users connected to the first user in a social networking graph;
generating, by one or more processors in the computing device, one or more item recommendations based on at least a gap value of a parameter corresponding to the first user with respect to a reference value of the parameter and one or more association factors of the plurality of second users with one or both of each item in the plurality of items and the first user; and
transmitting, by the one or more transceivers, the generated one or more item recommendations to a mobile computing device associated with the first user over the communication network, wherein the generated one or more item recommendations are selectable by the first user, at the mobile computing device, for item utilization.

2. The method of claim 1, wherein the item list comprises at least one item from the plurality of items, wherein each item in the plurality of items is associated with the parameter.

3. The method of claim 2, further comprising determining, by the one or more processors in the computing device, a cumulative value of the parameter associated with the item list based on a value of the parameter associated with each item in the item list.

4. The method of claim 3, further comprising determining, by the one or more processors in the computing device, the gap value of the parameter, corresponding to the first user, based on the cumulative value of the parameter associated with the item list and the reference value of the parameter corresponding to the first user.

5. The method of claim 1, wherein the generation of the one or more recommendations is further based on profile information of the first user.

6. The method of claim 1, wherein a first association factor of the one or more association factors is based on an affinity score of the plurality of second users with the corresponding item in the plurality of items.

7. The method of claim 1, wherein a second association factor of the one or more association factors is based on a trust score between the plurality of second users and the first user.

8. The method of claim 1, wherein each item recommendation of the one or more item recommendations comprises details of one or more items from the plurality of items and/or details of one or more second users, in the plurality of second users, who are associated with the one or more items in the corresponding item recommendation.

9. The method of claim 1, further comprising updating, by the one or more processors in the computing device, the generated one or more item recommendations based on a feedback provided by the first user on at least one selected item recommendation.

10. The method of claim 1, wherein the parameter associated with an item corresponds to nutrients in a food item, a skill-set and/or training requirement of an employee in an organization.

11. A system for data processing for generating adaptive recommendations of relevant items, the system comprises:
one or more processors configured to:
receive data associated with a first user from one or more data sources over a communication network by utilizing one or more transceivers, wherein the data comprises an item list associated with the first user and information of a plurality of second users connected to the first user in a social networking graph;
generate one or more item recommendations based on at least a gap value of a parameter corresponding to the first user with respect to a reference value of the parameter, and one or more association factors of the plurality of second users with one or both of each item in the plurality of items and the first user; and
transmit the generated one or more item recommendations to a mobile computing device associated with the first user over the communication network by utilizing the one or more transceivers, wherein the first user provides a feedback, associated with item utilization, on the generated one or more item recommendations at the mobile computing device.

12. The system of claim 11, wherein the item list comprises at least one item from the plurality of items, wherein each item in the plurality of items is associated with the parameter.

13. The system of claim 12, wherein the one or more processors are further configured to determine a cumulative value of the parameter associated with the item list based on a value of the parameter associated with each item in the item list.

14. The system of claim 13, wherein the one or more processors are further configured to determine the gap value of the parameter, corresponding to the first user, based on the cumulative value of the parameter associated with the item list and the reference value of the parameter corresponding to the first user.

15. The system of claim 11, wherein the generation of the one or more recommendations is further based on profile information of the first user.

16. The system of claim 11, wherein a first association factor of the one or more association factors is based on an affinity score of the plurality of second users with the corresponding item in the plurality of items.

17. The system of claim 11, wherein a second association factor of the one or more association factors is based on a trust score between the plurality of second users and the first user.

18. The system of claim 11, wherein each item recommendation of the one or more item recommendations comprises details of one or more items from the plurality of items and/or details of one or more second users, in the plurality of second users, who are associated with the one or more items in the corresponding item recommendation.

19. The system of claim 11, wherein the one or more processors are further configured to update the generated one or more item recommendations based on a feedback provided by the first user on at least one selected item recommendation.

20. A computer program product for use with a computer, the computer program product comprising a non-transitory computer readable medium, wherein the non-transitory computer readable medium stores a computer program code for data processing for generating adaptive recommendations of relevant items, wherein the computer program code is executable by one or more processors in a computing device to:
receive data associated with a first user from one or more data sources over a communication network by utilizing one or more transceivers, wherein the data comprises an item list associated with the first user and information of a plurality of second users connected to the first user in a social networking graph;
generate one or more item recommendations based on at least a gap value of a parameter corresponding to the first user with respect to a reference value of the parameter, and one or more association factors of the plurality of second users with one or both of each item in the plurality of items and the first user; and
transmit the generated one or more item recommendations to a mobile computing device associated with the first user over the communication network by utilizing the one or more transceivers, wherein the first user provides a feedback, associated with item utilization, on the generated one or more item recommendations at the mobile computing device.
